(19) United States
(12) Patent Application Publication
(10) Pub. No.: US 2026/0236711 A1
(43) Pub. Date: Aug. 13, 2026

(54) SYSTEM AND METHOD FOR SUMMARIZATION OF LARGE-SCALE INPUT

(71) Applicant: Yext, Inc., New York, NY (US)

(72) Inventors: Ariana MARTINO, New York, NY (US); Rachel ADLER, New York, NY (US); Naman SEHGAL, Jersey City, NJ (US); Michael MISIEWICZ, Brooklyn, NY (US); Thomas MEYER, New York, NY (US); Patrick TERRY, Durham, NC (US); Matthew Hupman, Arlington, VA (US)

(73) Assignee: Yext, Inc., New York, NY (US)

(21) Appl. No.: 19/051,049

(22) Filed: Feb. 11, 2025

(51) Int. Cl. G06F 40/40; G06F 40/289; G06F 40/30

(52) U.S. Cl. CPC G06F 40/40; G06F 40/289; G06F 40/30

(57) ABSTRACT

A workflow that enhances LLM summarization through structured pre-processing and post-processing is disclosed. Pre-processing reduces data size while preserving key information. It segments text, embeds meaning, clusters similar content, and selects representative samples. This ensures efficient use of LLM context windows. The LLM generates structured summaries from sampled data. Post-processing validates summaries by retrieving supporting content. It ranks relevance of each segment of text to the summary and filters the unsupported summary. This prevents hallucinations and improves interpretability. The combined approach ensures concise, accurate, and evidence-backed summaries.

### BACKGROUND

### 1. Technical Field

The present disclosure relates to machine learning summarization techniques and more specifically to summaries generated from large-scale user-generated content.

### 2. Introduction

LLM (Large Language Model) summarization has been recently used to process user-generated content. As an example, businesses rely on the summaries of the user-generated content, such as reviews, to gather feedback on their products or services. However, conventional LLM summarization has limitations. In particular, a single LLM request has restricted context windows, limiting the amount of text that may be processed in one request. Even with larger context windows, conventional LLM struggles to find key insights in the vast number of user-generated content. As a result, important details may be lost among redundant or irrelevant data. Moreover, LLM-generated summaries sometimes lack citations (i.e., validation from the original user-generated content), so that summarized points cannot easily be traced back to the original text. As an example, LLMs sometimes generate hallucinated content with no supporting evidence.

In order to address these limitations of current LLM summarization, additional pre-processing and post-processing steps are desired. These steps help improve summary accuracy, ensure relevance of the summaries, and provide transparency by linking summaries to its original source.

### SUMMARY

Additional features and advantages of the disclosure will be set forth in the description that follows, and in part will be understood from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Disclosed are systems, methods, and non-transitory computer-readable storage media which provide a technical solution to the technical problem described. A method for performing the concepts disclosed herein can include: transforming a plurality of word spans of a natural language dataset into a plurality of embedded vectors; clustering the plurality of embedded vectors into one or more clusters based on a relative position of each of the plurality of embedded vectors; selecting at least one sample word span from the one or more clusters; and generating a summary of the word spans by executing a machine learning model on the at least one sample word span.

A system configured to perform the concepts disclosed herein can include: at least on processor; and a non-transitory computer-readable storage medium having instructions stored which, when executed by the at least one processor, cause the at least one processor to perform operations comprising: receiving a natural language dataset; dividing the natural language dataset into a plurality of word spans; transforming the plurality of word spans of a natural language dataset into a plurality of embedded vectors; clustering the plurality of embedded vectors into one or more clusters based on a relative position of each of the plurality of embedded vectors; selecting at least one sample word span from the one or more clusters; generating a summary of the word spans by executing a machine learning model on the at least one sample word span; transforming the summary into a first embedded vector; calculating a cosine similarity between the first embedded vector and the plurality of embedded vectors; determining a plurality of relevance scores, each based on the cosine similarity between the summary and each of the plurality of word spans of the natural language dataset; and accepting the summary if at least one of the plurality of relevance scores is above a threshold value.

A non-transitory computer-readable storage medium configured as disclosed herein can have instructions stored which, when executed by at least one processor, cause the at least one processor to perform operations which include: receiving a natural language dataset; dividing the natural language dataset into a plurality of word spans; transforming the plurality of word spans of a natural language dataset into a plurality of embedded vectors; clustering the plurality of embedded vectors into one or more clusters based on a relative position of each of the plurality of embedded vectors; selecting at least one sample word span from the one or more clusters; transforming the summary into a first embedded vector; generating a summary of the word spans by executing a machine learning model on the at least one sample word span; transforming the summary into a first embedded vector; calculating a cosine similarity between the first embedded vector and the plurality of embedded vectors; determining a plurality of relevance scores, each based on the cosine similarity between the summary and each of the plurality of word spans of the natural language dataset; and accepting the summary if at least one of the plurality of relevance scores is above a threshold value.

### BRIEF DESCRIPTION OF THE DRAWINGS

FIG. 1 illustrates an example system embodiment for generating summaries in accordance with the present disclosure;

FIG. 2A illustrates various exemplary pre-processing steps of the LLM summarization in accordance with the example system in FIG. 1;

FIG. 2B illustrates various exemplary post-processing steps of the LLM summarization in accordance with the example system in FIG. 1;

FIG. 3A illustrates an exemplary validation step performed in the various post-processing steps of the LLM summarization in accordance with FIG. 2B;

FIG. 3B illustrates an exemplary similarity distribution histogram in accordance with the validation step in FIG. 3A;

FIG. 4A illustrates an exemplary display of a plurality of summaries in accordance with the present disclosure;

FIG. 4B illustrates an exemplary analysis result of one summary of the plurality of summaries in accordance with FIG. 4A;

FIG. 5 illustrates an example method embodiment in accordance with the present disclosure; and

FIG. 6 illustrates an example computer system in accordance with the present disclosure.

### DETAILED DESCRIPTION

Various embodiments of the disclosure are described in detail below. While specific implementations are described, this is done for illustration purposes only. Other components and configurations may be used without parting from the spirit and scope of the disclosure.

System and methods disclosed herein efficiently summarize large-scale user-generated content by combining various pre-processing and post-processing steps with LLM summarization. These pre-and post-processing steps address key limitations of conventional LLM summarization. In particular, the pre-processing steps may reduce the large dataset size while preserving important content. Thus, these pre-processing steps help overcome the constraint of limited context window imposed by a single LLM summarization request.

The post-processing steps may address the issue of interpretability and validation. LLM-generated summaries often lack clear links to the original text, making it difficult to verify accuracy. By retrieving relevant source content, the post-processing steps may ensure that each summary point is supported by actual data in the original text. The post-processing steps may also eliminate hallucinated summaries that have no evidence in the original dataset.

In some embodiments, the pre-processing steps may begin by obtaining or being provided data, such as recent user-generated content retrieved from a database. Then, a segmentation step breaks long entries of content, such as text, into smaller segments, such as sentence-level segments. Each sentence-level segment may have a more focused topic than the overall content. Next, an embedding step converts each segment into a numerical vector that represents a semantic meaning of the segment. In this way, the vectors representing segments with similar meanings would be closer together in the embedded vector space, and segments with very different meanings would be spatially apart. Using these embeddings, a clustering step groups semantically related segments together, ensuring that related segments are processed collectively even when these related segments come from different sources, such as content generated by different users. As another step before the LLM summarization, a sampling step selects a proportionate subset of segments from each cluster, reducing the redundancy of the segments while still maintaining a diversity of topics. Together, these pre-processing steps may create a concise yet representative dataset for LLM summarization.

In some embodiments, following the pre-processing steps, the LLM may receive a structured summarization request. The request may include instructions and the sampled segments generated from the pre-processing steps. The LLM then generates one or more summaries, such as summary bullets, each representing a key topic found in the sampled content. Each summary bullet may include a title, description, sentiment (positive or negative), and a theme that aligns with an existing taxonomy. In some embodiments, the LLM may generate a suggested theme in the case that there are no appropriate themes in the existing taxonomy.

In some embodiments, the post-processing steps validates the summary bullets generated in the LLM summarization. The post-processing steps may begin with a search step, where the full dataset is scanned to find at least one piece of original content that supports each summary bullet. Then, a relevance ranking step sorts the retrieved segments by a relevance score calculation to the summary title, ensuring the most relevant content appears first. In some embodiments, the relevance score calculation is based on a cosine similarity calculation. Finally, a cutoff and validation step filter out unsupported summary bullets by applying a threshold, removing any summary bullets without sufficient evidence. These steps ensure that every generated summary bullet is traceable, reliable, and free from hallucinations.

Although the following examples are related to summarizing online customer reviews, it should be appreciated that the system and method disclosed herein may be used for summarizing data that is not limited to online reviews. As an example, the system and method disclosed herein may be used to summarize data such as customer search queries, or social posts, to help a brand determine what information is important to its customers.

Alternatively or additionally, the system may compare a newly generated review summary with a previously generated summary to identify changes in customer feedback over time. By analyzing differences between summaries, the system can detect emerging trends, shifts in sentiment, or changes in the frequency of certain topics. For example, if an earlier summary emphasized complaints about product durability, but a newer summary highlights improved durability and increased customer satisfaction, the system can infer that recent product improvements have been well received.

Based on these detected changes, the system may generate recommendations. If a comparison of summaries comparison reveals a growing number of negative reviews about shipping delays, the system can recommend an operational review of the logistics process. Conversely, if new positive themes emerge—such as increased praise for customer service—the system may suggest leveraging this insight for marketing efforts. In another example, if customers initially praised a product's affordability but recent summaries show concerns over price increases, the system could recommend evaluating pricing strategies or promotional discounts.

Additionally, comparing summaries over time can help brands understand seasonal patterns in customer feedback. For instance, a sporting goods retailer may observe that during summer months, reviews frequently mention heat resistance in running shoes, whereas winter reviews focus more on traction and warmth. The system could use this insight to adjust marketing campaigns and product recommendations based on seasonal trends.

By continuously monitoring and summarizing changes in customer feedback, the system enables businesses to proactively respond to evolving consumer preferences, address emerging concerns, and capitalize on positive developments in their products or services.

The description next turns to the specific examples provided by the figures.

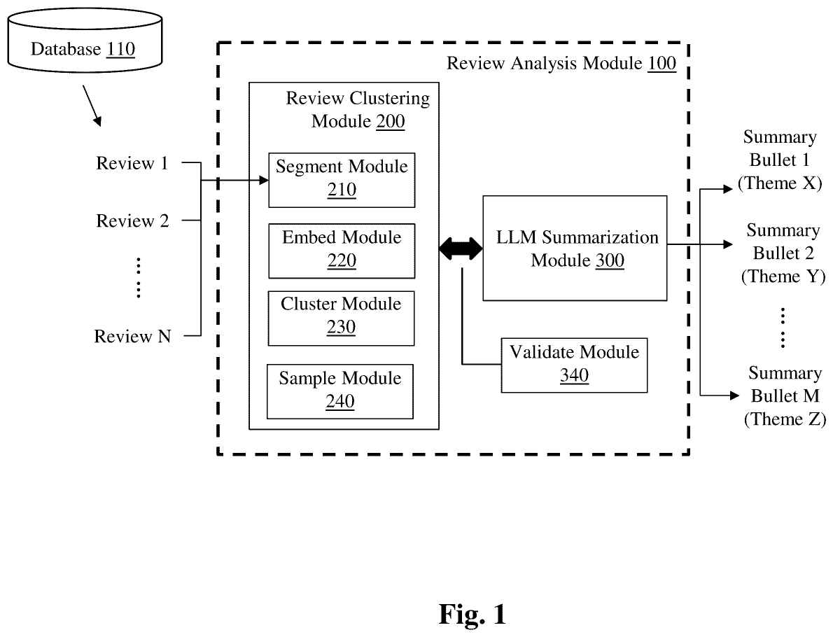

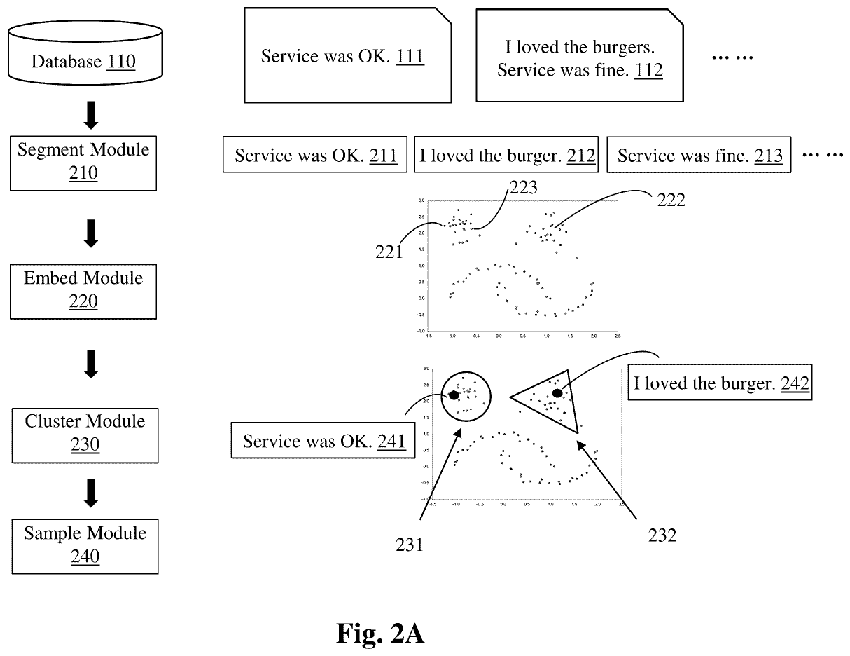

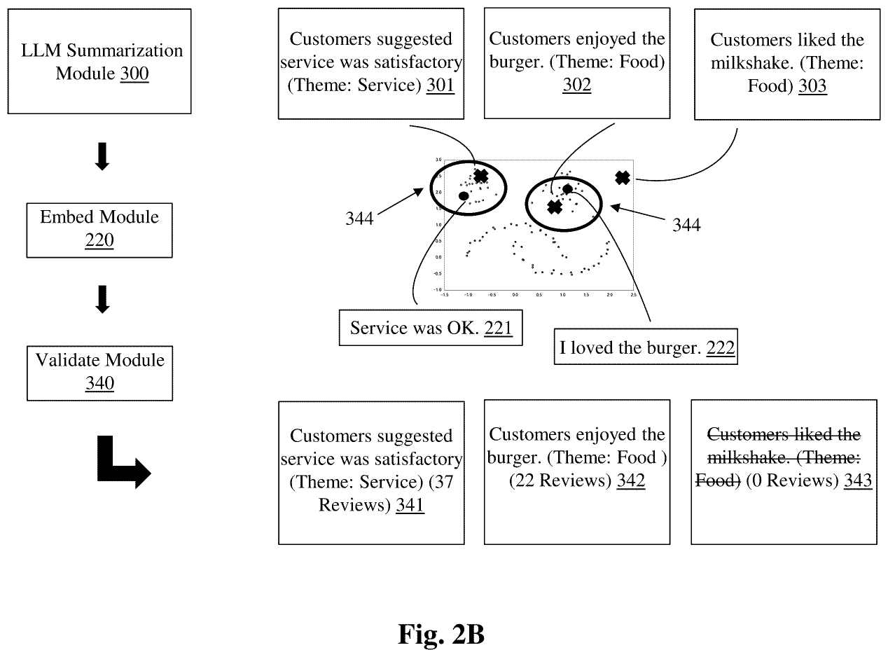

FIG. 1 illustrates an example system embodiment. The example is related to summarizing large online review content datasets for a business. As illustrated, a plurality of reviews, such as Review 1, Review 2 . . . Review N from a data base 110 are processed by a review analysis module 100 to generate one or more summary bullets, such as summary bullet 1, summary bullet 2 . . . to summary bullet M. Here M and N are both integers. Each summary bullet 1, 2 . . . M may be associated with a theme X, Y . . . Z. The theme of each summary bullet may be a general topic of the review that the business has opted to track over time. For example, a theme may be “customer service”. Different summary bullets may share the same theme, for example, X equals Y. More details related to the theme are described in relation to FIG. 2B.

The theme of one summary bullet may be from the business's existing taxonomy. For example, a hair salon may opt to track various themes of their service, such as “store hours”. Accordingly, a summary bullet stating, “Customers were inconvenienced by early closing hours” would be assigned to the theme of “store hours”. Alternatively, the LLM summarization module 300 inside the review analysis module 100 may generate a suggested theme for a summary bullet if there are no relevant themes in the business's existing taxonomy. As an example, if the abovementioned hair salon initially did not opt to track a theme of “pet-friendliness”, while a summary bullet of the hair salon states, “guests complain about not letting their pets in”, then the LLM summarization module 300 may assign the new theme of “pet-friendliness” to the summary bullet. Advantageously, the example system illustrated in FIG. 1 may help businesses identify topics that are coming up in the reviews that the business may not previously be aware of.

As illustrated in FIG. 1, the plurality of reviews for a business over a period of time, such as a week, are obtained or provided from the database 110. Other time periods are also contemplated and can be used as desired. Then, the reviews may undergo various pre-processing steps in a review clustering module 200 before being fed into the LLM summarization module 300. The review clustering module 200 may include multiple modules. Each module may handle a specific pre-processing step. For example, a segment module 210 generates sentence-level segments by splitting longer text in a review into shorter, focused units. An embed module 220 converts each segment into an embedded vector that represents that segment's semantic meaning. A cluster module 230 groups segments with similar meanings by clustering their corresponding embedded vectors. A sample module 240 selects a representative subset of segments from each cluster to reduce redundancy while preserving topic diversity.

Also illustrated in FIG. 1 is a validate module 340 interconnecting the review clustering module 200 and the LLM summarization module 300. For each summary bullet generated by the LLM summarization module 300, the validate module 340 may search the full space of the review segments out of the embed module 220 and determine which one or more segments entail the summary bullet. Advantageously, the review analysis module 100 may only output summaries that have an identified source within the review data. Alternatively, the review analysis module may output all the summaries and flag those that do not have an identified source within the review data using a validation model by the validate module 340. More details on the functions of each module are discussed with reference to FIG. 2A and FIG. 2B.

FIG. 2A illustrates an example flow of pre-processing steps in accordance with the present disclosure. The example in FIG. 2A relates to the pre-processing steps of summarizing multiple reviews of a dining experience at a restaurant. On the left of FIG. 2A is a data flow from FIG. 1 and illustrates the data flow among the multiple modules within the review clustering module 200. On the right of FIG. 2A is a step-by-step illustration corresponding to the data flow through each module on the left. The images on the right illustrate how the plurality of reviews 111, 112 . . . are transformed into sample segments, such as 241 and 242.

Initially, the plurality of reviews 111, 112 from the database 110 are input into the segment module 210. Each review may include one or more sentences. For example, review 112 contains two sentences, i.e., “I loved the burgers” and “Service was fine”. After the segmenting process, the reviews 111, 112 are divided into individual, sentence-level segments 211, 212 and 213. As a next step, the embedding model used in the embed module 220 creates a representation of the semantic meaning of each segment 211, 212 and 213 as a vector of floats, corresponding to 221, 222, and 223 respectively, in the vector space. Vectors representing segments with similar meanings would be closer together, and segments with very different meanings would be spatially further apart. As a result, the vectors 221 and vector 223, which both relate to “service” are close to each other, whereas the vector 222 relating to “food” is far apart from 221 and 223.

Following the embedding step, the cluster module 230 groups the vectors 221, 222 and 223 describing similar feedback via one or more clustering algorithms. As an example, HDBSCAN is a hierarchical clustering algorithm that may take in the set of vectors 221, 222 and 223 and assign these vectors into clusters 231 and 232 that are semantically similar. As a result, the vectors 221 and 223 both relating to “service” are grouped into the circular shaped cluster 231. The vector 222 relating to “food” is grouped into the triangular shaped cluster 232, together with other food related review vectors. One advantage of using HDBSCAN is the flexibility in the number of clusters and the size of clusters depending on the distribution of vectors in the dataset. In some embodiments, other algorithms may be used together with HDBSCAN. For example, for very large datasets, computing an exact distance matrix between all segment pairs using HDBSCAN may be computationally expensive. To address this challenge, a fast nearest-neighbor search algorithm pynndescent is used to construct an approximate k-nearest neighbors graph, which estimates distances between vectors with high accuracy but much lower computational cost than HDBSCAN. Advantageously, by using this precomputed graph, HDBSCAN can then perform the clustering without needing to compute a full distance matrix between each vector pair, significantly improving scalability and processing speed for large datasets.

Following the clustering step, the sample module 240 selects a stratified sample of segments across the clusters. For the illustrated example, a sample segment 241 “Service was OK” relating to “service” is selected from the cluster 231 and another sample segment 242 “I loved the burger” relating to “food” is selected from the cluster 232. For larger number of clusters and more segments in each cluster, samples from each cluster may be included proportionally to the size of each cluster. Preferably, each cluster may be represented at least once in the samples. In some embodiments, the number of sample segments may be fewer than the number of clusters. For example, the number of sample segments is 100 and the number of clusters is 200. In this situation, the sampling step may prioritize sampling based on the size of the cluster, that is, the top 100 clusters in size may each be represented once in the 100 samples. Other sampling strategies are also contemplated and may be tuned based on the need or nature of the business.

With the sampling step, the original dataset is substantially reduced in size and the duplicative review segments are eliminated. Advantageously, the various pre-processing steps combined may accommodate topics of varying sizes and specificities. Additionally, these pre-processing steps select a reliable sample of review data for later LLM summarization to accommodate context window and performance limitations.

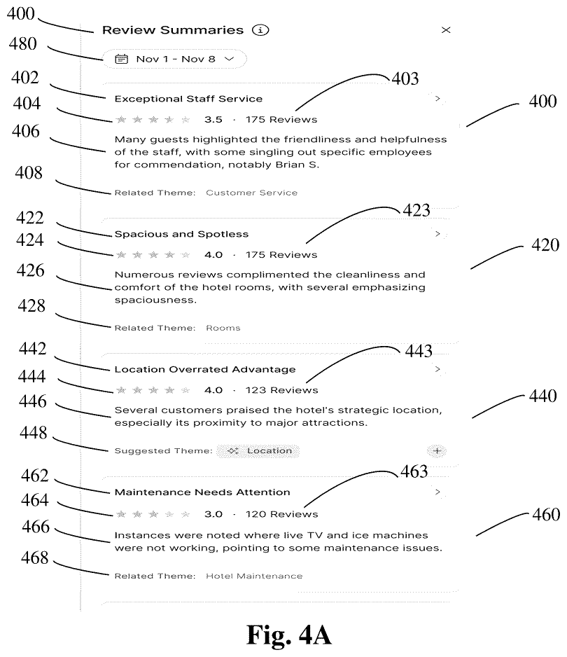

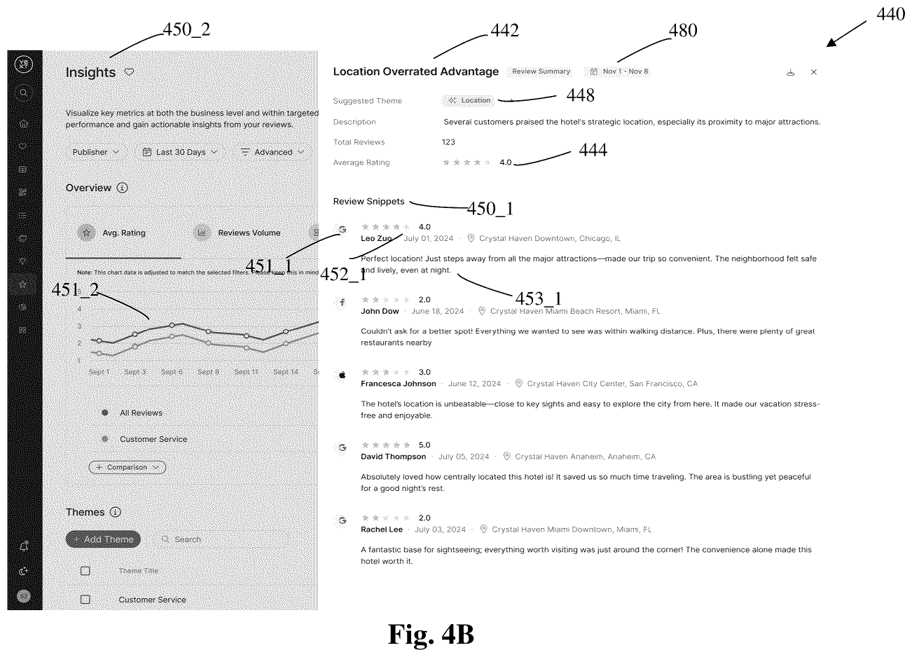

FIG. 2B illustrates an example flow of the LLM summarization step and related post-processing steps in accordance with the present disclosure. The LLM summarization module may output a number of summaries in the form such as summary bullets 301, 302 and 303. Each summary bullet may include a topic (theme) section, a title section, a positive/negative sentiment section (not shown in 301, 203 and 303) and a description section (not shown in 301, 302 and 303), as will be described in more details in FIG. 4A.

As should be appreciated from the foregoing discussion, due to the limitations of conventional LLM summarization, some summary bullets may not be associated with at least one review in the review data and are thus hallucinated summaries. In order to identify these hallucinated summaries, the summary bullets 301, 302 and 303 are also embedded in the same way as the original review segments, by the embed module 220 to generate summary bullet vectors. These summary bullet vectors are denoted as cross-shaped points and are displayed together with the original review vectors in the vector space.

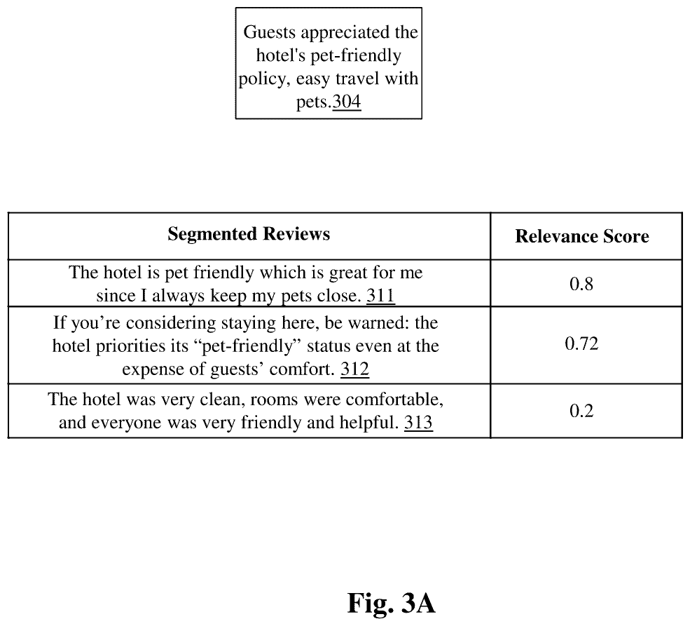

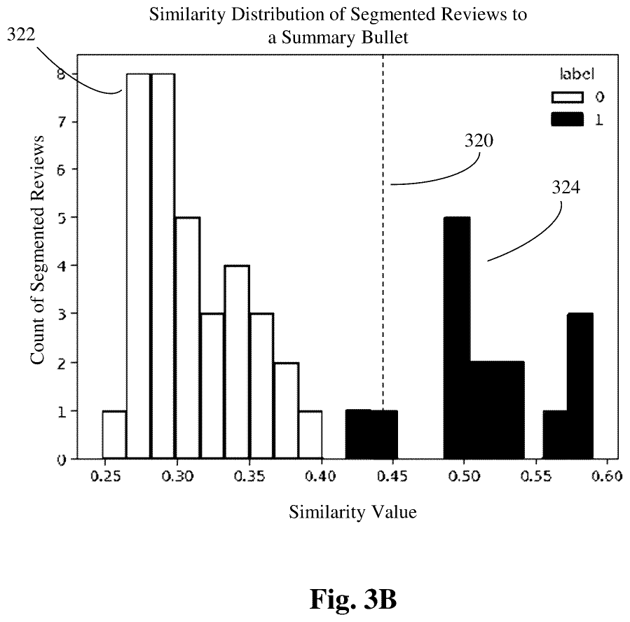

Next, the validate module 340 may run a validation model to calculate a relevance between each review vector in the original review dataset and the summary bullet vectors. For example, the validate module may calculate a cosine similarity (relevance) between each review vector and the summary bullet vector. Then, the validate module 340 may rank each review vector in a descending order based on the relevance with the summary bullet vector, as will be shown in FIG. 3A and FIG. 3B.

Using the ranked relevance list, the validate module 340 may split the segments into two categories, i.e., “relevant” and “not relevant” based on a threshold value. The threshold value may be determined based on observations of an ideal threshold value from manually labeling “relevant” and “not relevant” review vectors across multiple test datasets. The threshold value may be adjusted for different review datasets or for a different review gathering periods.

FIG. 3A illustrates an example output of a validate module 340. The summary bullet 304 states “Guests appreciated the hotel's pet-friendly policy, easy travel with pets”. As illustrated by the table, the validate module 340 is able to rank the relevance, based on the cosine similarity calculation between each segmented review and the summary bullet 304 of the three segmented reviews 311, 312 and 313 in view of the summary bullet 304. In this example, the highest relevance of 0.8 corresponds to the review 311. Review 311 states that “The hotel is pet friendly which is great for me since I always keep my pets close.” It can be seen that the review 311 is entirely about describing the pet-friendly policy. As a result, the review 311 has a high relevance to the summary bullet 304. The next highest relevance of 0.7 corresponds to the review 312. Review 312 states that “If you're considering staying here, be warned: the hotel priorities its “pet-friendly” status even at the expense of guests'comfort.” It can be seen that the review 312 not only comments on the pet-friendly policy but also mentions “comfort”. As a result, the relevance of the review 312 to the summary bullet 304 is lower than that of the review 313. The lowest relevance of 0.2 corresponds to the review 313. Review 313 states that “The hotel was very clean, rooms were comfortable, and everyone was very friendly and helpful.” It can be seen that the review 313 is not related to the pet-friendly policy at all. As a result, the review 313 has the lowest relevance to the summary bullet 304, compared with the other two reviews.

FIG. 3B further illustrates a distribution of segmented reviews according to the relevance to a summary bullet. In this example, the relevance is calculated based on a cosine similarity value between each review segment and the summary bullet. As illustrated, the vertical axis of the distribution is the count of segmented reviews, and the horizontal axis is the similarity value (relevance). The dashed line 320 near the middle of the histogram represents the threshold value. In one embodiment, the threshold value 320 may be a pre-determined value. Specifically, the threshold value 320 may be determined experimentally by first manually labeling a small number of summary—segmented review pairs. From there, the threshold value 320 that most accurately partitioned between the “relevant” and “not relevant” reviews are determined. This pre-determined threshold value 320 may not change when there are new reviews added to the review dataset. Alternatively, the threshold value 320 may be an adjustable value which is updated based on an updated review dataset. In another embodiment, the threshold value 320 may be dependent on various features of a review dataset, such as the field of business. In the example illustrated in FIG. 3B, the threshold value 320 is a pre-determined value of 0.43. It can be seen that most review segments unrelated to “pet-friendliness” (denoted in white) have relevance numbers lower than the threshold value 320 of 0.43 and most review segments related to “pet-friendliness” (denoted in black) have relevance numbers higher than this threshold value 320. In addition, the relevant review segments may include a number of review segments, the corresponding relevance values of which are distributed around and/or above the threshold value 320 (denoted by the black histogram intersected by the threshold value 320).

FIG. 4A illustrates a review summary 400 including multiple summary bullets 400, 420, 440 and 460 in accordance with the summary bullets 301, 302 and 303 in FIG. 2B. The review summary is generated by summarizing reviews within a time period 480. According to the foregoing discussion, each summary bullet may include multiple sections. For example, each summary may have a title section 402, 422, 442 and 462, a sentiment section denoted by the number of stars 404, 424, 444 and 464, a description section 406, 426, 446 and 466, a theme section 408, 428, 448 and 468. Additionally, each summary may also include the number of reviews 403, 423, 443 and 463.

When embedding these summary bullets into vectors, different embedding approaches may be considered. For example, multiple embedding models, such as EncodeMPNetEmbed and EncodeBertEmbed may both be tested. Additionally, the input to the embedding models may also be tested. As an example, some tests embed both the title and description of a summary bullet into a vector, while other tests only embed the title into a vector and ignore the description. The calculation of relevance in FIG. 3A and FIG. 3B is based on the combination of the EncodeMPNetEmbed model with the title only embedding, however, alternative combinations of embedding method and embedding inputs are also contemplated.

FIG. 4B illustrates an example analysis interface on a specific summary bullet 440, according to the present disclosure. As illustrated, in addition to the title 442, time period 480, theme 448, and sentiment 444, there is also a review snippets section 450_1 and an insights section 450_2. Both sections 450_1 and 450_2 may help a business identify the source and evidence for a summary bullet 440 within their review data. Within the review snippets section 450_1, individual reviews that are relevant to the summary bullet 440 are displayed as a list, such that a business may be able to view all relevant individual reviews and their related parameters (date, location, etc.). Each individual review may include a publisher section 451_1, a review sentiment section 452_1 and a review content section 453_1. Advantageously, a business may further use the insights section 450_2 to visualize various trends in the reviews, for example, by plotting the averaged review score vs. dates of the review in a graph 451_2.

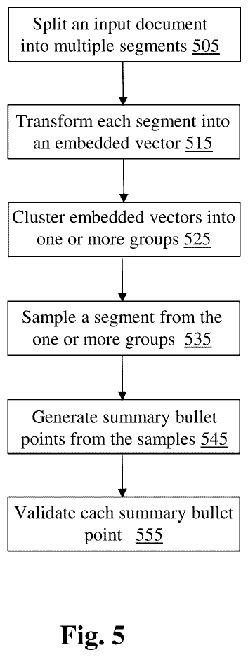

FIG. 5 illustrates an example method embodiment according to the present disclosure. At step 505, the full dataset is split into a plurality of segments. At step 515, the plurality of segments are transformed into a plurality of embedded vectors. At step 525, the plurality of embedded vectors are grouped into one or more clusters. At step 535, at least one sample segment from the one or more clusters is selected. At step 545, one or more summaries are generated based on the sample segment. At step 555, the one or more summaries are transformed into embedded vectors to be validated against the full dataset.

The summaries generated through this process may serve as valuable insights for various downstream applications. One key use case is personalized product recommendations. Brands can leverage summarized review data from customers to match customer preferences with highly rated products. For example, if a customer is looking for a running shoe with strong support and cushioning, the system may query existing summaries to identify shoes frequently mentioned in reviews for those features. This enables data-driven product suggestions based on real user feedback rather than static product descriptions.

As another potential application, summarization can help businesses identify gaps in their data. For example, if a platform collects customer feedback on products but rarely receives reviews on product durability, a summary could highlight the lack of long-term usage insights. Businesses could then take actions by prompting customers for follow-up reviews after extended use or offering surveys focused on durability.

Beyond making recommendations, summary-based insights can assist businesses in optimizing services across different locations. A restaurant chain, for instance, could compare summarized reviews across multiple locations to identify patterns in customer feedback, such as consistent praise for service quality or recurring complaints about wait times. Businesses can use this information to tailor their strategies at different locations, ensuring a more consistent and improved customer experience.

Additionally, businesses can use summarized insights to refine marketing strategies and customer engagement. If a common theme in reviews highlights affordability and durability as key selling points for a product, marketing efforts can emphasize these strengths to attract new customers. Similarly, customer service teams can use summaries to quickly address frequent concerns, improving overall customer satisfaction.

By integrating these validated summaries into recommendation systems, operational decisions, and customer engagement strategies, businesses can make informed, data-driven choices that enhance customer experience and drive sales.

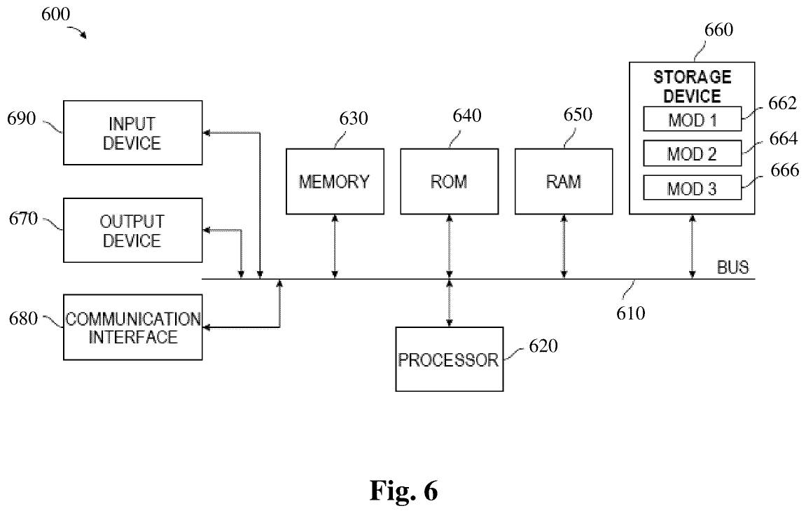

With reference to FIG. 6, an exemplary system includes a computing device 600 (such as a general-purpose computing device), including a processing unit (CPU or processor) 620 and a system bus 610 that couples various system components including the system memory 630 such as read-only memory (ROM) 640 and random access memory (RAM) 650 to the processor 620. The computing device 600 can include a cache of high-speed memory connected directly with, in close proximity to, or integrated as part of the processor 620. The computing device 600 copies data from the system memory 630 and/or the storage device 660 to the cache for quick access by the processor 620. In this way, the cache provides a performance boost that avoids processor 620 delays while waiting for data. These and other modules can control or be configured to control the processor 620 to perform various actions. Other system memory 630 may be available for use as well. The system memory 630 can include multiple different types of memory with different performance characteristics. It can be appreciated that the disclosure may operate on a computing device 600 with more than one processor 620 or on a group or cluster of computing devices networked together to provide greater processing capability. The processor 620 can include any general-purpose processor and a hardware module or software module, such as module 1 662, module 2 664, and module 3 666 stored in storage device 660, configured to control the processor 620 as well as a special-purpose processor where software instructions are incorporated into the actual processor design. The processor 620 may essentially be a completely self-contained computing system, containing multiple cores or processors, a bus, memory controller, cache, etc. A multi-core processor may be symmetric or asymmetric.

The system bus 610 may be any of several types of bus structures including a memory bus or memory controller, a peripheral bus, and a local bus using any of a variety of bus architectures. A basic input/output (BIOS) stored in memory ROM 640 or the like, may provide the basic routine that helps to transfer information between elements within the computing device 600, such as during start-up. The computing device 600 further includes storage devices 660 such as a hard disk drive, a magnetic disk drive, an optical disk drive, tape drive or the like. The storage device 660 can include software modules 662, 664, 666 for controlling the processor 620. Other hardware or software modules are contemplated. The storage device 660 is connected to the system bus 610 by a drive interface. The drives and the associated computer-readable storage media provide nonvolatile storage of computer-readable instructions, data structures, program modules and other data for the computing device 600. In one aspect, a hardware module that performs a particular function includes the software component stored in a tangible computer-readable storage medium in connection with the necessary hardware components, such as the processor 620, system bus 610, output device 670 (such as a display or speaker), and so forth, to carry out the function. In another aspect, the system can use a processor and computer-readable storage medium to store instructions which, when executed by a processor (e.g., one or more processors), cause the processor to perform a method or other specific actions. The basic components and appropriate variations are contemplated depending on the type of device, such as whether the computing device 600 is a small, handheld computing device, a desktop computer, or a computer server.

Although the exemplary embodiment described herein employs the storage device 660 (such as a hard disk), other types of computer-readable media which can store data that are accessible by a computer, such as magnetic cassettes, flash memory cards, digital versatile disks, cartridges, random access memories (RAMs) 650, and read-only memory (ROM) 640, may also be used in the exemplary operating environment. Tangible computer-readable storage media, computer-readable storage devices, or computer-readable memory devices, expressly exclude media such as transitory waves, energy, carrier signals, electromagnetic waves, and signals per se.

To enable user interaction with the computing device 600, an input device 690 represents any number of input mechanisms, such as a microphone for speech, a touch-sensitive screen for gesture or graphical input, keyboard, mouse, motion input, speech and so forth. An output device 670 can also be one or more of a number of output mechanisms known to those of skill in the art. In some instances, multimodal systems enable a user to provide multiple types of input to communicate with the computing device 600. The communications interface 680 generally governs and manages the user input and system output. There is no restriction on operating on any particular hardware arrangement and therefore the basic features here may easily be substituted for improved hardware or firmware arrangements as they are developed.

The computing device 600 may be described in the general context of computer system-executable instructions, such as program modules, being executed by a computer system. Generally, program modules may include routines, programs, objects, components, logic, data structures, and so on that perform particular tasks or implement particular abstract data types. In configurations where the computing device 600 is used in a distributed cloud computing environment (such as where the computing device 600 utilizes one or more servers) where tasks are performed by remote processing devices that are linked through a communications network. In a distributed cloud computing environment, program modules may be located in both local and remote computer system storage media including memory storage devices.

The technology discussed herein refers to computer-based systems and actions taken by, and information sent to and from, computer-based systems. One of ordinary skill in the art will recognize that the inherent flexibility of computer-based systems allows for a great variety of possible configurations, combinations, and divisions of tasks and functionality between and among components. For instance, processes discussed herein can be implemented using a single computing device or multiple computing devices working in combination. Databases, memory, instructions, and applications can be implemented on a single system or distributed across multiple systems. Distributed components can operate sequentially or in parallel.

Use of language such as “at least one of X, Y, and Z,” “at least one of X, Y, or Z,” “at least one or more of X, Y, and Z,” “at least one or more of X, Y, or Z,” “at least one or more of X, Y, and/or Z,” or “at least one of X, Y, and/or Z,” are intended to be inclusive of both a single item (e.g., just X, or just Y, or just Z) and multiple items (e.g., {X and Y}, {X and Z}, {Y and Z}, or {X, Y, and Z}). The phrase “at least one of” and similar phrases are not intended to convey a requirement that each possible item must be present, although each possible item may be present.

The various embodiments described above are provided by way of illustration only and should not be construed to limit the scope of the disclosure. Various modifications and changes may be made to the principles described herein without following the example embodiments and applications illustrated and described herein, and without departing from the spirit and scope of the disclosure. For example, unless otherwise explicitly indicated, the steps of a process or method may be performed in an order other than the example embodiments discussed above. Likewise, unless otherwise indicated, various components may be omitted, substituted, or arranged in a configuration other than the example embodiments discussed above.

We claim:

1. A method comprising:
transforming a plurality of word spans of a natural language dataset into a plurality of embedded vectors;
clustering the plurality of embedded vectors into one or more clusters based on a relative position of each of the plurality of embedded vectors;
selecting at least one sample word span from the one or more clusters; and
generating a summary of the word spans by executing a machine learning model on the at least one sample word span.

2. The method of claim 1, further comprising:
transforming the summary into a first embedded vector;
calculating a cosine similarity between the first embedded vector and the plurality of embedded vectors;
determining a plurality of relevance scores, each based on the cosine similarity between the summary and each of the plurality of word spans of the natural language dataset ; and
accepting the summary if at least one of the plurality of relevance scores is above a threshold value.

3. The method of claim 2, wherein the threshold value is a pre-determined value.

4. The method of claim 2, wherein the threshold value is determined based on the natural language dataset.

5. The method of claim 1, wherein the clustering further comprises:
executing a first clustering algorithm to generate an approximate distance matrix among the plurality of embedded vectors; and
executing a second clustering algorithm to generate the one or more clusters, wherein an input to the second clustering algorithm is based on the approximate distance matrix.

6. The method of claim 5, wherein a first cluster of the one or more clusters comprises a first number of reviews and a second cluster of the one or more clusters comprises a second number of reviews.

7. The method of claim 6, wherein the at least one sample word span comprises a first number of sample word spans associated with the first cluster and a second number of sample word spans associated with the second cluster, wherein the first and second number of the sample spans are based on the first and second number of reviews.

8. The method of claim 2, wherein the summary comprises a title section, a description section and a theme section, the method further comprising:
transforming only the title section of the summary into the first embedded vector.

9. The method of claim 8, wherein the theme section comprises a suggested theme based on the machine learning model.

10. The method of claim 1, wherein the machine learning model is a Large Language Model.

11. The method of claim 1, further comprising:
receiving a natural language dataset; and
dividing the dataset into the plurality of word spans.

12. A system comprising:
at least on processor; and
a non-transitory computer-readable storage medium having instructions stored which, when executed by the at least one processor, cause the at least one processor to perform operations comprising:
receiving a natural language dataset;
dividing the natural language dataset into a plurality of word spans;
transforming the plurality of word spans of a natural language dataset into a plurality of embedded vectors;
clustering the plurality of embedded vectors into one or more clusters based on a relative position of each of the plurality of embedded vectors;
selecting at least one sample word span from the one or more clusters;
generating a summary of the word spans by executing a machine learning model on the at least one sample word span;
transforming the summary into a first embedded vector;
calculating a cosine similarity between the first embedded vector and the plurality of embedded vectors;
determining a plurality of relevance scores, each based on the cosine similarity between the summary and each of the plurality of word spans of the natural language dataset; and
accepting the summary if at least one of the plurality of relevance scores is above a threshold value.

13. The system of claim 12, wherein the clustering further comprises:
executing a first clustering algorithm to generate an approximate distance matrix among the plurality of embedded vectors; and
executing a second clustering algorithm to generate the one or more clusters, wherein an input to the second clustering algorithm is based on the approximate distance matrix.

14. The system of claim 13, wherein:
a first cluster of the one or more clusters comprises a first number of reviews and a second cluster of the one or more clusters comprises a second number of reviews; and
the at least one sample word span comprises a first number of sample word spans associated with the first cluster and a second number of sample word spans associated with the second cluster, wherein the first and second number of the sample spans are based on the first and second number of reviews.

15. The system of claim 12, wherein the summary comprises a title section, a description section and a theme section, and wherein the theme section comprises a suggested theme based on the machine learning model.

16. The system of claim 15, the non-transitory computer-readable storage medium having additional instructions stored which, when executed by the at least one processor, causes the at least one processor to perform operations comprising:
transforming only the title section of the summary into the first embedded vector.

17. A non-transitory computer-readable storage medium having instructions stored which, when executed by at least one processor, cause the at least one processor to perform operations comprising:
receiving a natural language dataset;
dividing the natural language dataset into a plurality of word spans;
transforming the plurality of word spans of a natural language dataset into a plurality of embedded vectors;
clustering the plurality of embedded vectors into one or more clusters based on a relative position of each of the plurality of embedded vectors;
selecting at least one sample word span from the one or more clusters;
generating a summary of the word spans by executing a machine learning model on the at least one sample word span;
transforming the summary into a first embedded vector;
calculating a cosine similarity between the first embedded vector and the plurality of embedded vectors;
determining a plurality of relevance scores, each based on the cosine similarity between the summary and each of the plurality of word spans of the natural language dataset; and
accepting the summary if at least one of the plurality of relevance scores is above a threshold value.

18. The non-transitory computer-readable storage medium of claim 17, having additional instructions stored which, when executed by the at least one processor, cause the at least one processor to perform operations comprising:
executing a first clustering algorithm to generate an approximate distance matrix among the plurality of embedded vectors; and
executing a second clustering algorithm to generate the one or more clusters, wherein an input to the second clustering algorithm is based on the approximate distance matrix.

19. The non-transitory computer-readable storage medium of claim 18, wherein:
a first cluster of the one or more clusters comprises a first number of reviews and a second cluster of the one or more clusters comprises a second number of reviews; and
the at least one sample word span comprises a first number of sample word spans associated with the first cluster and a second number of sample word spans associated with the second cluster, wherein the first and second number of the sample spans are based on the first and second number of reviews.

20. The non-transitory computer-readable storage medium of claim 17, wherein the summary comprises a title section, a description section and a theme section, the non-transitory computer-readable storage medium having additional instructions stored which, when executed by the at least one processor, cause the at least one processor to perform operations comprising:
transforming only the title section of the summary into the first embedded vector.
